(19) United States
(12) Patent Application Publication
(10) Pub. No.: US 2004/0205483 A1
(43) Pub. Date: Oct. 14, 2004

(54) Method of simulating the creation of an artist's drawing or painting and device for accomplishing same

(76) Inventor: Yefim Massarsky, Newton, MA (US)

Correspondence Address: MIRICK O'CONNELL, MIRICK O'CONNELL, DEMALLIE & LOUGEE, LLP, 1700 WEST PARK DRIVE, WESTBOROUGH, MA, 01581-3941, US

(21) Appl. No.: 10/092,368

(22) Filed: Mar. 6, 2002

Related U.S. Application Data
(63) Continuation of application No. 09/258,922, filed on Mar. 1, 1999, now Pat. No. 6,385,628.

(51) Int. Cl. G09G 5/12

(52) U.S. Cl. 715/500.1

(57) ABSTRACT

A method of simulating the creation of an artist's drawing or painting, and a device for accomplishing and printing the simulation.

### CROSS-REFERENCE

This is a continuation of U.S. application Ser. No. 08/258,922 filed on Mar. 1, 1999.

### FIELD OF THE INVENTION

This invention relates to photobooths and other similar vending machines and the methods used to simulate the creation of an artist's drawing or painting of an image taken of and/or provided by the user at the machine.

### BACKGROUND OF THE INVENTION

Vending machines and more specifically self-photography booths are well known in the art. Self-photography booths capable of producing a composite image from a live image superimposed on a background stored in a computer at the booth are also known in the art. However, none of the self-photography booths thus far offers a caricature as the final image, or a visual simulation of the gradual process by which an artist would paint or draw a portrait. Enabling a photobooth to simulate an artist's gradual creation of a portrait adds commercial value to the photobooth, and provides the user with a unique form of entertainment in addition to a hard copy of the final image.

### SUMMARY OF THE INVENTION

Therefore, an object of the invention is to provide a method of creating a caricature of an image taken of or provided by the user at a photobooth.

It is a further object of the invention to provide a method of simulating the creation of an artist's drawing or painting of a portrait.

It is a further object of the invention is to provide a device which creates a caricature of an image taken of or provided by the user at a photobooth.

It is a further object of the invention to provide a device which simulates the creation of an artist's drawing or painting of a portrait.

This invention features a method of simulating the creation of a mock artist's work from an electronically stored image, comprising the steps of storing at least one texture corresponding to a mock artist style, selecting portions of the electronically stored image according to a sequence, and displaying, in the sequence, on a computer monitor a representation of each selected portion of the electronically stored image based upon the at least one texture in each selected portion of the electronically stored image.

The method may further include the step of creating a hard copy of the image displayed on the computer monitor after all of the portions of the electronically stored image have been displayed. The selecting step may include the step of identifying groups of pixels in the electronically stored image which have similar parameter values as a single portion. The parameter values may be grey scale or color values.

The selecting step may include the step of determining a sequence for the portions of the electronically stored image such that at least one selected portion in the sequence is not contiguous with an immediately preceding selected portion in the sequence. The selecting step may include the steps of identifying groups of pixels in the electronically stored image which have similar parameter values as single portions, and determining a sequence for the portions of the electronically stored image such that separate portions having similar parameter values are grouped in the sequence.

The displaying step may include the step of gradually displaying the representation for a portion. The displaying step may further include the steps of moving an icon across the computer monitor at areas corresponding to the selected portions, and displaying the representation of each selected portion along the path traversed by the icon. The icon may be moved according to a predetermined pattern. The representation of each selected portion may be first displayed while the icon is at the area corresponding to the portion.

The step of storing at least one texture may include the step of storing a plurality of textures corresponding to a plurality of mock artist's styles. The method may further comprise the step of selecting a mock artist's style from the plurality of mock artist's styles, and wherein the at least one texture corresponding to the selected mock artist's style is used in the displaying step. The method may further comprise the steps of capturing an electronic image from an input device, and storing the captured electronic image as the electronically stored image.

Also featured in this invention is a system for simulating the creation of a mock artist's work, comprising a memory having an electronically stored image, a computer monitor, a memory having at least one texture corresponding to a mock artist style, means for selecting portions of the electronically stored image according to a sequence, and means for displaying, in sequence, on the computer monitor, a representation of each selected portion of the electronically stored image based upon the at least one texture in the selected portion of the electronically stored image.

The system may further comprise an image capture device for capturing and storing the electronically stored image. The image capture device may be a video camera. The system may further comprise an output device for creating a hard copy of the displayed image. The means for selecting may include means for identifying groups of pixels in the electronically stored image which have similar parameter values as a single portion. The means for selecting may further comprise means for identifying groups of pixels in the electronically stored image which have similar parameter values as a single portion, and means for determining a sequence for the portions of the electronically stored image such that separate portions having similar parameter values are grouped in the sequence.

The means for displaying may include means for gradually displaying the representation for a portion. The means for displaying may comprise means for moving an icon across the computer monitor at areas corresponding to the selected portions and the means for displaying may further comprise means for displaying the representation of each selected portion along the path traversed by the icon.

The icon may be moved according to a predetermined pattern. The means for displaying may first display the representation of each selected portion while the icon is at the area corresponding to the portion. The system may further comprise a memory storing a plurality of textures corresponding to a plurality of mock artists' styles. The system may further comprise means for selecting a mock artist's style from the plurality of mock artists' styles and wherein the at least one texture corresponding to the selected mock artist's style is used in the means for displaying. The system may still further comprise means for selecting a mock artist's style from the plurality of mock artists' styles, and the means for displaying may include means for displaying at least one texture corresponding to the selected mock artist's style.

Also featured is a photography booth for creating a printed output of a mock artist's drawing or painting image, comprising a means for accepting monetary payment to enable creation of the printed output, a printer, a computer with memory, means for storing an image in the computer memory, means for selecting a mock artist having a predetermined artistic style, means for storing at least one display texture corresponding to the selected mock artist's predetermined artistic style, means for substituting one or more of the stored textures for different areas of the stored image to create an electronic mock artist's drawing or painting image corresponding to the selected artist's predetermined artistic style, and means for printing the mock artist's image.

### BRIEF DESCRIPTION OF THE DRAWINGS

Other objects, features and advantages will occur to those skilled in the art from the following description of a preferred embodiment, and the accompanying drawings, in which:

FIG. 1 is a simplified schematic diagram of a system of this invention capable of accomplishing the methods of this invention;

FIG. 2A is a cross-sectional schematic view of a photo booth which accomplishes the system of FIG. 1;

FIG. 2B is a schematic diagram of another photo booth which accomplishes this invention;

FIG. 3 is a schematic diagram of the preferred method of this invention;

FIG. 4. is exemplary of a manner of assigning a first set of control points on a fixed image and establishing a distance between the control points, for use in this invention;

FIG. 5 is exemplary of a manner of altering the distance between at least two control points and defining a second set of control points which incorporates the altered distances;

FIG. 6 is exemplary of two different manners of substituting the grey scale value of the input image with textures representative of two different artists, for use in this invention;

FIG. 7A is a more schematic representation of a portion of a displayed mock image, which is helpful in illustrating the preferred manner in which the image of this invention is created by the method of this invention;

FIG. 7B is an enlarged schematic view of a portion of FIG. 7A, illustrating the path of the icon which simulates the creation of the mock image in the preferred embodiment of the method of this invention; and

FIG. 8 is a simplified example of the monitor of FIGS. 1 and 2 during or just at the completion of the creation of the mock artist drawing or painting according to a method of this invention.

### DESCRIPTION OF THE PREFERRED METHOD AND EMBODIMENT

The method of the invention of creating a caricature of an image taken of or provided by a user at a photobooth, may be generally accomplished using the steps of: providing an image fixing device; fixing the image at the photobooth with the image fixing device; assigning a first set of control points at predetermined locations on the fixed image; establishing a distance between the control points; altering the distance between at least two of the control points; defining a second set of control points which incorporates the altered distances; and rendering the caricature in a visible format using the second set of control points.

In the rendering step, the fixed image is translated, using the second set of control points, into computer instructions capable of creating the desired displayed and/or printed mock artist's drawing or painting of the caricature. An icon is preferably displayed on the monitor on which the caricature is to be created. The icon is moved across the monitor, and the caricature is created gradually along the path followed by the icon, to simulate a sketch or painting created by an artist's hand. One or more predefined display textures are used to create the visual appearance of the image. The completed caricature may then be printed as a hard copy for the user to save. Alternatively, the caricature can be created by the computer and simply provided as a hard copy output, such as a printed paper or engraved wood or metal piece, and/or an electronically-stored format such as CD ROM, disk, or computer or video tape. This invention also equivalently contemplates portraits that are not caricatures, as more fully described below.

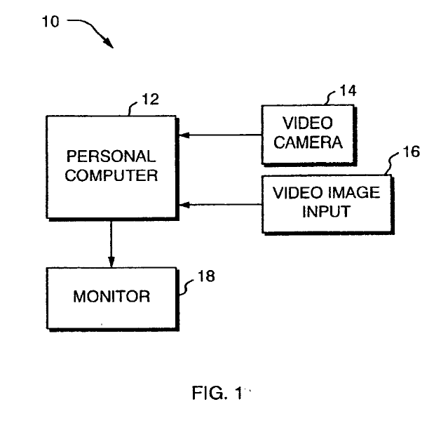

FIG. 1 is a simplified schematic diagram of system 10 of this invention, which may be used to accomplish the methods of this invention. Personal computer 12 has memory, typically in the form of a hard drive or RAM as appropriate depending on the computer and the size of the file. An electronic image to be recreated in this invention is received into the memory. The image may be provided by video camera 14, which can capture either a live image or an image of a photograph placed in front of the video camera, or the image can be input to computer 12 as a digital file 16. Personal computer 12 has a standard video grabber board such as a Flashpoint by Integral Technologies.

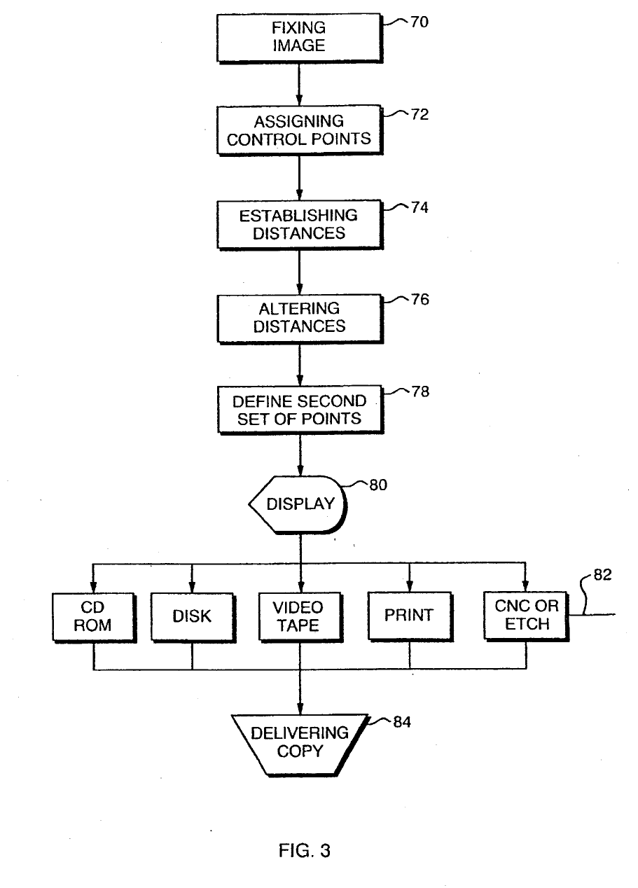

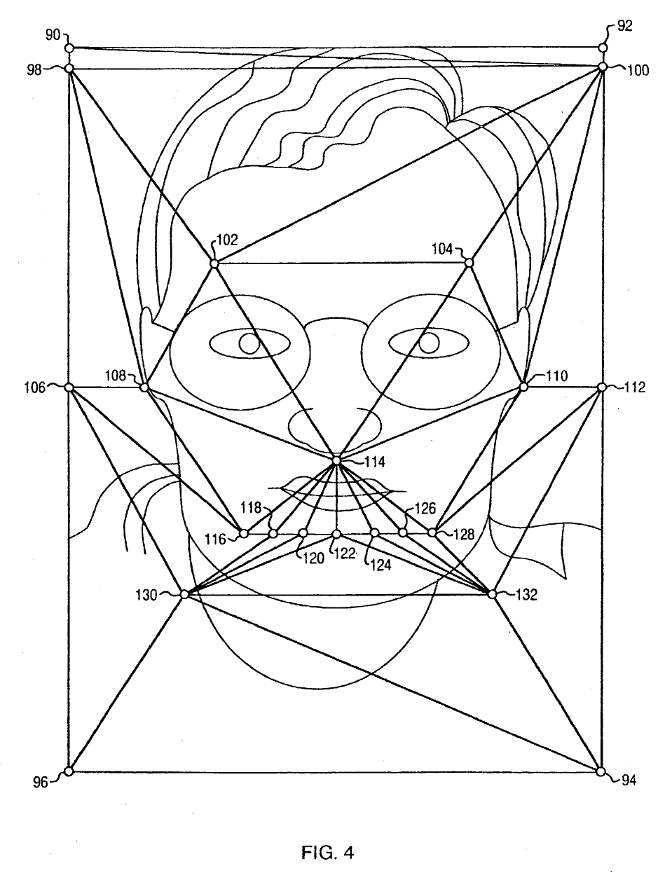

As shown in FIG. 3, the method of the invention (as applied to the creation of a caricature), which in part utilizes software resident in computer 12, fixes the image in step 70; in step 72 assigns a set of control points at critical locations on the image captured by video camera 14; in step 74 establishes a distance between the assigned control points; in step 76 alters the established distances between at least two control points; and in step 78 defines a second set of control points which incorporates the altered distances. The image area is preferably partitioned into triangular sub-regions. The partitioning is accomplished under the direction of a set of “control points”. FIG. 4 shows a pattern of triangles that result from an example set of control points.

The specific triangle selection is not absolutely critical for this embodiment, as long as a few simple criteria are met. First, every triangle vertex is a control point. Second, all control points must have at least three adjacent triangles. Third, no polygon contained within the image has more than three vertices. For triangulation purposes, the four corners of the image act as implied control points.

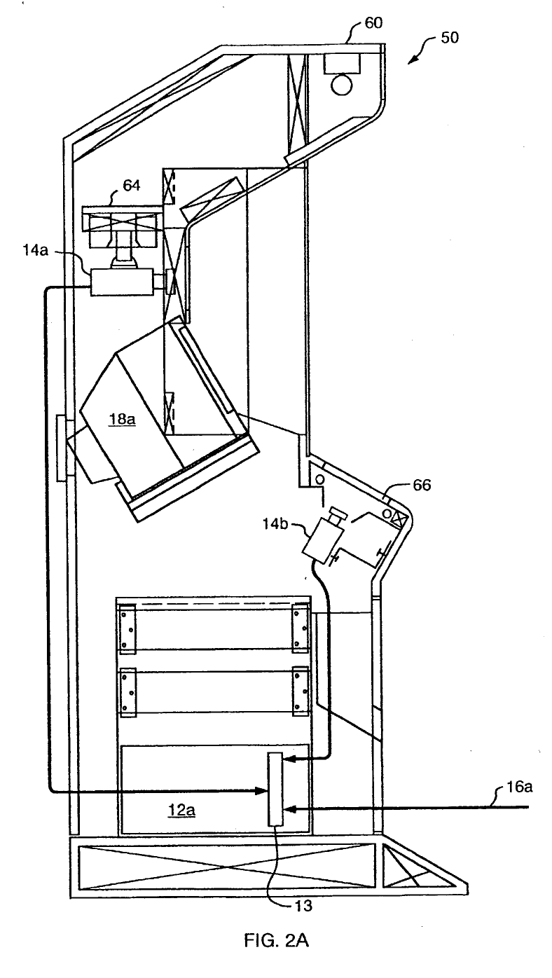

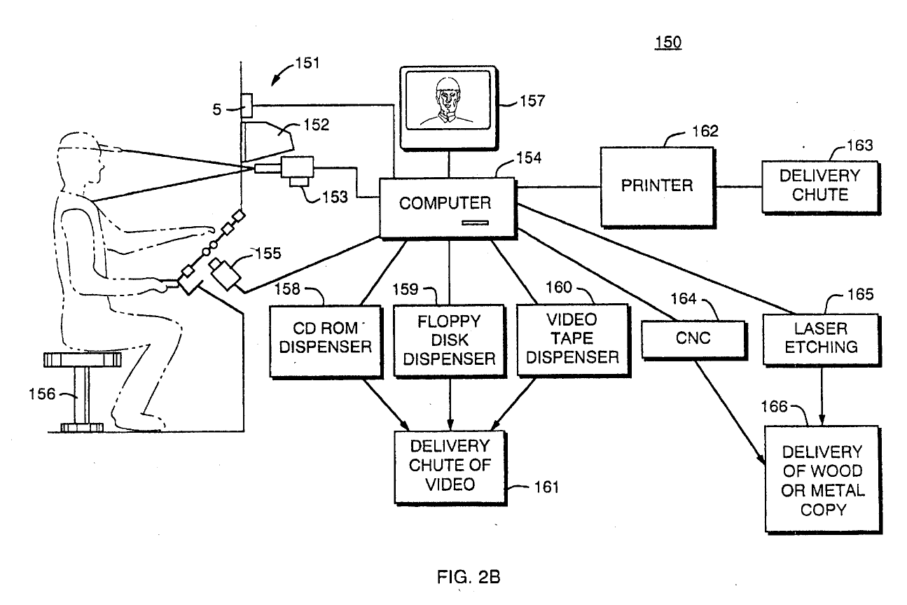

One or more image sub-regions are altered in shape, position and alignment by a repositioning of the triangle vertices. The image sub-region contained within the triangle is stretched and moved in accordance with the change in the bounding triangle. The process creates the visual appearance of the caricature, which is then displayed on monitor 18 in step 80. The method may further include steps 82 and 84 in which a retrievable copy of the caricature is created and the copy is delivered to the user via chute 161 or 163 shown in FIG. 2B.

In steps 72, 74, 76 and 78, one method of the invention utilizes software based on a technique known in the art as polynomial warping. The preferred method works backward from the warped image to locate the source of each pixel. For each triangle in the resulting warped image, the method locates the corresponding pixels (picture elements) in the original source image (the camera input) and copies them to their changed locations. The method applies two-dimensional bilinear interpolation when reading the source pixels to obtain a higher quality image.

As shown in FIG. 4, a pattern of triangles are mapped out on the captured images. A lattice of control points is assigned according to where the vertices of the mapped triangles are located, and the distance between adjacent control points or vertices is established. The different sets of control points are chosen by an artist with knowledge of the warping process in anticipation of the visual effect produced. The preferred embodiment chooses visual transformations that are visually identifiable to customers as facial features or facial expressions expressing recognizable moods.

The control points could also be selected automatically under program control. One possible implementation would try to identify facial features contained within the image, would look for facial attributes that diverge from the norm, would assign control points in relation to these diverging facial attributes, and would choose transformations to emphasize these attributes. The attributes checked and highlighted by the method would be pre-determined and stored within the program.

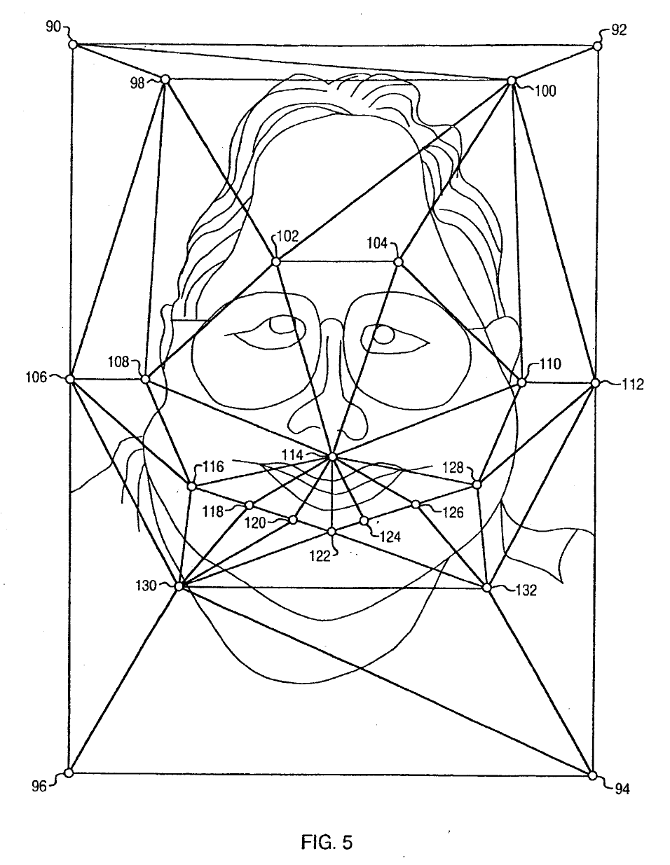

For example, FIG. 4 illustrates an image captured by video camera 14 on which appears a predetermined pattern of adjacent triangles, the vertices of which will determine the control points. The image shown in FIG. 4 comprises a total of 34 triangles which together form 22 control points, specifically, control points 90-132. As shown, each triangle has two or more vertices that are common with one or more adjacent triangles. As such, when the distance between two control points is altered, the dimensions of two or more adjacent triangles are in turn altered as well, as shown in FIG. 5.

The warping effect is accomplished by increasing or decreasing the distance between two or more predetermined control points, in effect, reassigning or moving predetermined control points to a new location. In the example shown in FIGS. 4 and 5, the location of control points 98, 100, 102, 104, 116, 118, 120, 124, 126 and 128 is changed. Both the reassigned control points (98, 100, 102, 104, 116, 118, 120, 124, 126 and 128) and the control points which remain in their originally assigned location (90, 92, 94, 96, 106, 108, 110, 112, 114, 122, 130 and 132) are used to define a second set of control points from which the final caricature is processed. As noted above, the preferred method of warping generates an inverse transform. As such, the preferred method maps out the image of FIG. 5 and works backward from the control points of FIG. 5 to the control points of FIG. 4 to calculate the destination address. For example, control points 102 and 104, as shown in FIG. 5, have been reassigned a new address, as shown in FIG. 4, thus increasing the distance between points 102 and 104. Increasing the distance between points 102 and 104 effectively changes the size and shape of the seven triangles of which control points 102 and 104 are common vertices. Therefore, the source pixels located within triangle 100, 102, 104, as shown in FIG. 4, are reassigned and condensed to fill the destination pixels in corresponding triangle 100, 102 and 104, as shown in FIG. 5.

It is envisioned that the method of the invention may be further or alternatively configured to rotate, scale or translate the captured image into an altered image. The method may also use another technique for warping an image known as morphing which utilizes higher-ordered polynomials and combines or otherwise superimposes two or more images.

The software may also be configured to generate and display on monitor 18 an icon which is used to simulate the drawing or painting of the mock artist image. The software translates an electronically-stored image into instructions capable of creating a mock image. These instructions are used to move the icon across the monitor. The image is created gradually in the path which the icon follows, to simulate the drawing or painting of the image by the icon. The icon can take any desired shape, for example an artist's hand with a pencil or paintbrush, or a more fantastic image such as an animal or other object which moves about monitor 18 as shown in FIG. 8.

The method of FIG. 3 and the system of FIG. 1 may be accomplished in a freestanding self-photography booth such as booth 50, FIG. 2A. Booth 50 includes video camera 14a with positioning device 64 which may be controlled by a user, not shown, standing or sitting in front of camera 14a to capture a live image of the user. Booth 50 is also shown as including second video camera 14b which is pointed at glass plate 66 on which may be placed a photograph which the user desires to have translated into a mock artist's drawing or painting image. It is also possible to include another image input source 16a, which could be accomplished with a modem or other connect device to allow the input of an electronic image file.

The desired video input is routed to video board 13 of personal computer 12a. Software resident in computer 12a directs the creation of the mock artist drawing or painting image on monitor 18a. When the image creation process is complete, the image may be printed out with a standard printer such as a Hewlett Packard laser printer, not shown in the drawing.

FIG. 2B is a schematic diagram of another embodiment of system 150 of this invention, which may be used to practice the method of this invention. Photo booth 151 has user-operated camera position and image selection buttons labeled 1-4, and money input device or credit card device 5 for enabling the system. A user sits on seat 15b and a portrait of the user is captured by video camera 153, whose input is provided to personal computer 154. Second video camera 155 is pointed at a glass plate (not shown) to capture an image of a still photograph, as described above. User monitor 152 displays the appropriate image for viewing by the user, and second monitor 157 displays the same image to others. System 150 includes the provision of a hard copy and/or an electronic copy of the mock image created by the system, and/or a video clip of the process by which the mock image was created, which the user can take with him and play back as desired by the user on a computer or VCR, to entertain the user. These recorded animation sequences can be created and dispensed on any available portable, machine-readable memory device media, such as CD ROM dispenser 158, floppy disk dispenser 159, and video tape dispenser 160, each of which would be delivered through chute 161. Another possibility would be the use of a modern to transmit an electronic file comprising a digital video clip of the image creation process.

System 150 also provides different types of hard copy output of the image created. Printer 162 can deliver a paper copy through chute 163. A copy could alternatively be engraved on a hard material such as wood, metal or plastic by CNC engraver 164, or etched with a device such as a laser etching machine 165, and delivered through chute 166.

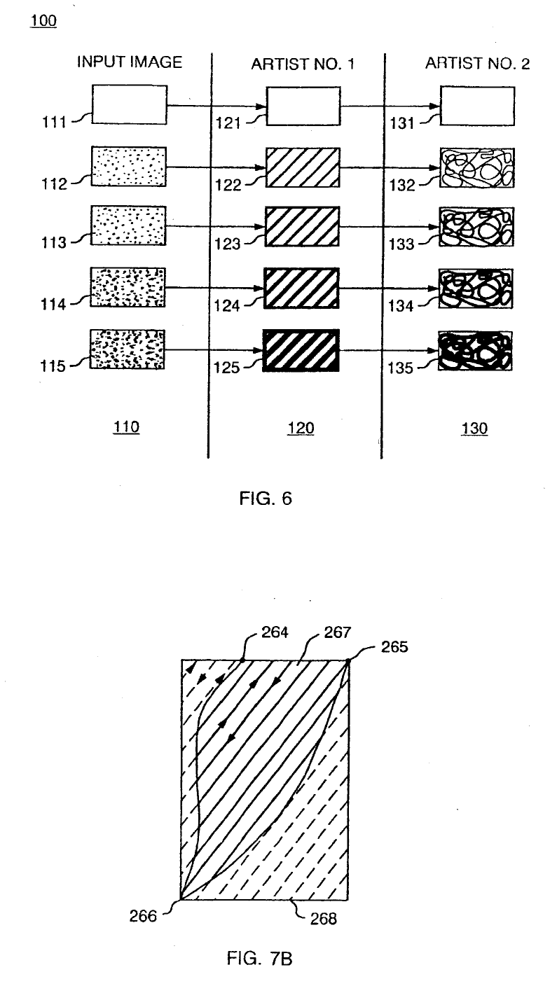

If the software is configured to generate and display on monitor 18 an icon which is used to simulate the drawing or painting of the mock output image of the caricature, the first step of the preferred method for accomplishing this simulation is to translate the electronically-stored image into instructions capable of creating the mock image. Software resident in the computer, in conjunction with the video board, is enabled to determine the grey scale value of each pixel of the electronically-stored caricature image. One or more display parameters other than grey scale (e.g. hue, RGB value, saturation) can be the parameter of the pixels for which a value is determined and used as set forth below. Grey scale will be used in the following discussion, but such does not limit the invention. The entire grey scale which may be recognized by the video system used has been previously divided into a number of groups. Preferably, these groups each represent contiguous portions of a digital grey scale spectrum. For example, with an eight bit video system, 256 grey scale values are supported. These 256 values can be divided into a number of groups. FIG. 6 displays five groups 111-115 in column 110. The size of, and grey scale values comprising, each group is a design choice, partially driven by the type of mock image output which it is desired to create. Column 110 in FIG. 6 is meant to represent grey scale values of increasing darkness from value 111 to value 115. The software then assigns the appropriate grey scale group value to each pixel of the electronically-stored image.

The method of this invention preferably allows for more than one type of artistic style to be used in creating the mock artist's image. This can be accomplished as follows. A number of display textures for each type of mock artist style are input into the personal computer. This may be accomplished by manually sketching such textures, each of which represents a progressively darker drawing or painting area, and/or a particular color for a color output. These different textures are then scanned into a computer and digitized to create instructions that are necessary to accomplish an output on the monitor which is representative of the scanned texture. FIG. 6 illustrates two groups of such scanned textures for two different artist styles, labeled “Artist Number 1” and “Artist Number 2”, columns 120 and 130, respectively. The artist number 1 style is accomplished by a series of ever-thicker diagonal lines which create an ever darker shading effect. A similar effect is created in textures 131-135 in column 130 using thicker and/or more closely spaced curved lines and other drawing portions. There are limitless possibilities for the creation of texture areas having different darkness which can be scanned into the computer.

The next step in translating the electronically stored image into instructions capable of creating the mock image is to effectively substitute the stored display textures for the portions of the electronically-stored image having the appropriate grey scale values. This may be accomplished as follows.

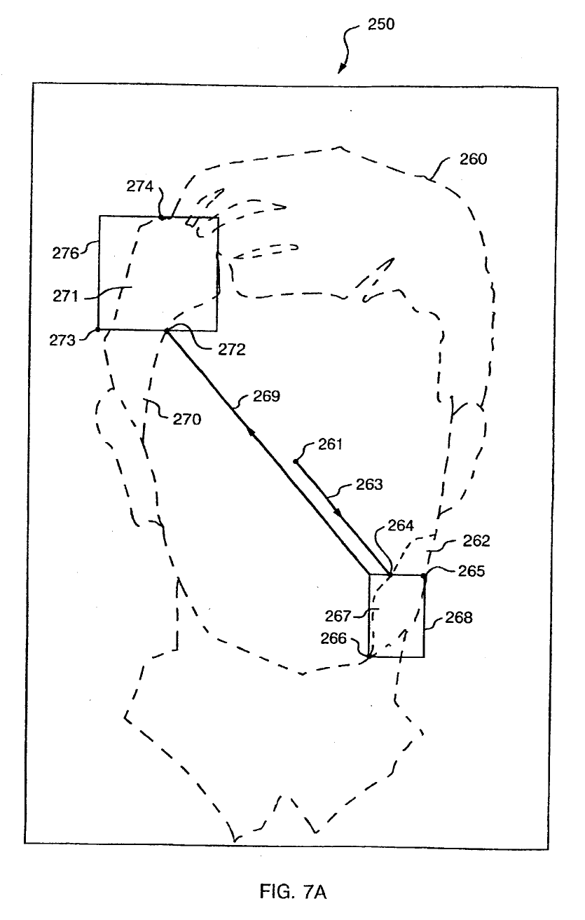

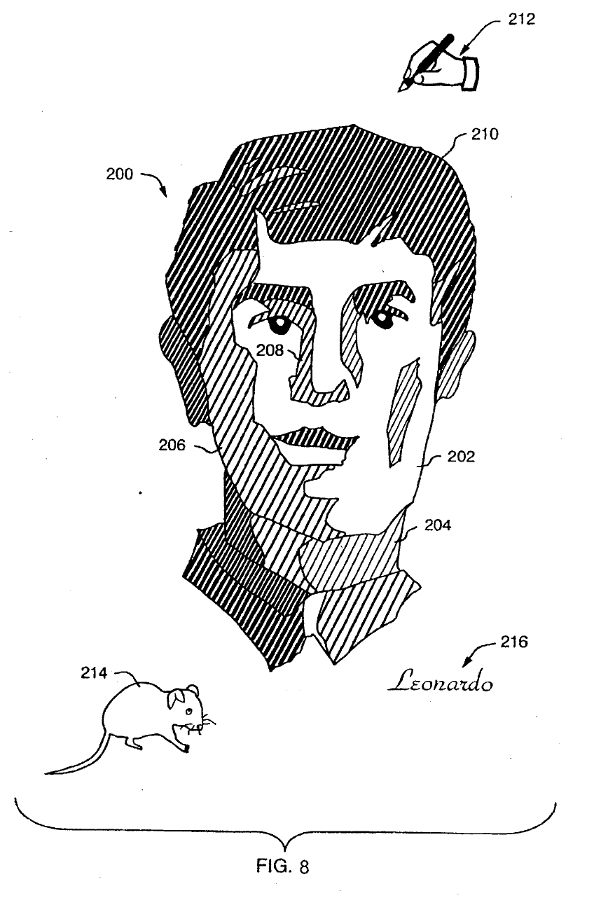

With reference to FIG. 7A, image area 250 bounded by the large rectangle includes image 260 (shown in phantom), which is the outline of a portrait. Image 260 is not the actual image created on the monitor by the method of this invention, but is merely an illustration of a portion of an image which is useful in explaining the preferred manner in which the correct textures are applied to areas of the image and created on the monitor.

Presuming that artist number 1 has been selected by the user, textures 121-125 are available for use. As described above, the computer has previously been programmed to substitute one of textures 121-125 for different portions of the grey scale spectrum of the electronically-stored image. The creation of the mock image on the monitor is accomplished as follows, with reference to FIGS. 7A and 7B. Operation begins at the center 261 of image area 250. A pointer (not displayed) is effectively moved diagonally down to the right along path 263 from center 261 at 45° from the horizontal, until the first pixel having a grey scale value in the range of the first texture (texture 121 when artist number 1 has been selected) is encountered. The procedure can start with any one of the textures, and does not have to proceed from lightest to darkest as will be explained below. This first pixel is illustrated as pixel 264 of contiguous image area 262 having pixels with grey scale values in the selected range. The pointer is then caused to move horizontally to the right until it stops encountering pixels in the grey scale range for the selected texture 121. This last contiguous point having a grey scale in that range is labeled 265 in the drawing. The pointer then drops down to the next row of pixels and traverses horizontally to the left, continuing until it hits the last contiguous pixel having a grey scale value in the selected range. From that point, the pointer again drops down and traverses to the right. Operation continues in this fashion until no more adjacent pixels having the correct grey scale value are found, labeled point 266 in the drawing. The software then draws a virtual rectangle around area 267 which has been traversed with the first point establishing the upper side of the rectangle, the last point establishing the lower side, and the right most and left most points establishing the right and left side of the rectangle, respectively. By this fashion, portion 267 of larger area 262 composed entirely of pixels having grey scale values in the selected range is identified. This area 267, and virtual rectangle 268, are shown enlarged in FIG. 7B.

The software then accomplishes the gradual display of area 267 on the computer output device. This is accomplished as follows, with reference to FIG. 7B. The drawing icon is positioned on the screen so that the end of the drawing implement is at the upper left hand corner of rectangle 268. The icon is then moved back and forth across diagonal lines shown by the broken lines in FIG. 7B. When a side of rectangle 268 is encountered, the pointer moves one pixel to the right or down, as appropriate, reverses direction, and traverses again. The end result is that the icon moves diagonally up and down across the entire area of rectangle 268, imitating the diagonal movement of the drawing implement which may he accomplished by an artist filling in an area with a particular texture. When the icon encounters pixels within area 267 which is to be shaded with the texture chosen to represent the grey scale range of the pixels within area 267, the software enables the monitor to display the texture along the path which the icon traverses. This displayed texture is indicated by the solid lines within area 267. The result is the application of the scanned texture to area 267 in a gradual fashion filling from the top left hand corner to the bottom right hand corner of rectangle 268. To an observer, this process appears as though the icon is drawing the texture in area 267, filling from the top left to the bottom right of the area being drawn, and leaving appropriate drawing lines which create the texture. This embodiment simulates a drawing process by a right handed artist. To simulate a left handed artist, the filling of the texture would be from the top right to the bottom left.

Once the displayed portion 267 is accomplished, the pointer moves to the top left hand corner of rectangle 268 and proceeds diagonally up along path 269 (parallel to path 263) until it encounters another pixel having a grey scale value in the selected range, labeled pixel 272, FIG. 7A. Since the pointer is moving up, the horizontal traversing which identifies area 271 to which will be applied the selected texture proceeds left to right and up, in the same fashion described below for area 267. Area 271 and encompassing rectangle 276 are created in the same fashion, and area 271 is filled with display texture in the same fashion as described below in relation to area 267. When display area 271 has been created, the pointer moves to the bottom right hand corner of rectangle 276 and proceeds diagonally downward to the right until it hits the next pixel having a grey scale value in the selected range. Operation proceeds in this fashion until each pixel in image 260 having a grey scale value in the selected range has been displayed on the monitor with the appropriate texture. Each of the other textures would then be applied to the image in the same fashion. The end result is that the icon moves across display 250 in an interesting and apparently somewhat random fashion, filling in small or large areas with different textures, until the entire image is created. Although in software image 260 can be created in mere seconds, the icon is typically enabled to move at a relatively slow speed such that most images take minutes to create, which accomplishes the entertainment value associated with the invention.

A simplified form of a completed image 200 is shown in FIG. 8. Image 200 has area 202 with the lightest texture, area 204 with the next darkest texture, area 206 with the next darkest texture, area 208 with the next darkest texture, and area 210 with the darkest texture. The software can also create on the output artist's “signature” 216, which helps to personalize the output. The signature is associated with the user-selected artist style and drawing icon. Also displayed in image 200 is drawing icon 212 which in this case is an artist's hand holding a pencil. Also displayed is observer icon 214 which could he an animal or a person, for example. Observer icon 214 may be placed to increase the entertainment value of this invention. Icon 214 is meant to simulate observers whom often observe and comment on live drawings by artists. Observer icon 214 can be simulated to make comments as the drawing is created, for example “you have captured the eyes well”. In another embodiment, observer 214 can appear to reach up and make a mark on image 200. The drawing icon could then be enabled to appear to say “sorry about that”, and produce an eraser and erase the mark, then continue with the drawing. There are endless possibilities for interaction between the drawing icon, the observer icon, and the actual observers of the process, limited only by the creative abilities of the programmer.

As a result, each caricature, and the process by which it is “created” on the monitor, is unique. There is thus entertainment value to the process. Any video clip of the process will be a unique cartoon movie, which has value. The video clip for each portrait will have a different duration, and the path the icon follows will be unique, because it is dependent on the shading of a particular caricature. Also, the observer icon comments can be selected randomly from a library of hundreds of different expressions. The time at which such comments are inserted into the drawing process may also be randomized.

Although specific features of this invention are shown in some drawings and not others, this is for convenience only as each feature may be combined with any or all of the other features in accordance with the invention.

Other embodiments will occur to those skilled in the art and are within the following claims:

1. A method of simulating the creation of a mock artist's work from an electronically stored image, comprising the steps of:
storing at least one texture corresponding to a mock artist style;
selecting portions of the electronically stored image according to a sequence; and
displaying, in the sequence, on a computer monitor, a representation of each selected portion of the electronically stored image based upon the at least one texture in each selected portion of the electronically stored image.

2. The method of simulating the creation of a mock artist's work from an electronically stored image according to claim 1, further comprising the step of creating a hard copy of the image displayed on the computer monitor after all of the portions of the electronically stored image have been displayed.

3. The method of simulating the creation of a mock artist's work from an electronically stored image according to claim 1, wherein the selecting step includes the step of identifying groups of pixels in the electronically stored image which have similar parameter values as a single portion.

4. The method of simulating the creation of a mock artist's work from an electronically stored image according to claim 3, wherein the parameter values are grey scale or color values.

5. The method of simulating the creation of a mock artist's work from an electronically stored image according to claim 1, wherein the selecting step includes the step of determining a sequence for the portions of the electronically stored image such that at least one selected portion in the sequence is not contiguous with an immediately preceding selected portion in the sequence.

6. The method of simulating the creation of a mock artist's work from an electronically stored image according to claim 1, wherein the selecting step includes the steps of:
identifying groups of pixels in the electronically stored image which have similar parameter values as single portions; and
determining a sequence for the portions of the electronically stored image such that separate portions having similar parameter values are grouped in the sequence.

7. The method of simulating the creation of a mock artist's work from an electronically stored image according to claim 1, wherein the displaying step includes the step of gradually displaying the representation for a portion.

8. The method of simulating the creation of a mock artist's work from an electronically stored image according to claim 7, wherein the displaying step further includes the steps of:
moving an icon across the computer monitor at areas corresponding to the selected portions; and
displaying the representation of each selected portion along the path traversed by the icon.

9. The method of simulating the creation of a mock artist's work from an electronically stored image according to claim 8, wherein the icon is moved according to a predetermined pattern.

10. The method of simulating the creation of a mock artist's work from an electronically stored image according to claim 8, wherein the representation of each selected portion is first displayed while the icon is at the area corresponding to the portion.

11. The method of simulating the creation of a mock artist's work from an electronically stored image according to claim 1, wherein the step of storing at least one texture includes the step of storing a plurality of textures corresponding to a plurality of mock artists' styles.

12. The method of simulating the creation of a mock artist's work from an electronically stored image according to claim 11, further comprising the step of selecting a mock artist's style from the plurality of mock artist's styles, and wherein the at least one texture corresponding to the selected mock artist's style is used in the displaying step.

13. The method of simulating the creation of a mock artist's work from an electronically stored image according to claim 1, further comprising the steps of:
capturing an electronic image from an input device; and
storing the captured electronic image as the electronically stored image.

14. A system for simulating the creation of a mock artist's work, comprising:
a memory having an electronically stored image;
a computer monitor;
a memory having at least one texture corresponding to a mock artist style;
means for selecting portions of the electronically stored image according to a sequence; and
means for displaying, in sequence, on the computer monitor a representation of each selected portion of the electronically stored image based upon the at least one texture in the selected portion of the electronically stored image.

15. The system for simulating the creation of a mock artist's work according to claim 14, further comprising an image capture device for capturing and storing the electronically stored image.

16. The system for simulating the creation of a mock artist's work according to claim 15, wherein the image capture device is a video camera.

17. The system for simulating the creation of a mock artist's work according to claim 14, further comprising an output device for creating a hard copy of the displayed image.

18. The system for simulating the creation of a mock artist's work according to claim 14, wherein the means for selecting includes means for identifying groups of pixels in the electronically stored image which have similar parameter values as a single portion.

19. The system for simulating the creation of a mock artist's work according to claim 14, wherein the means for selecting further comprises:
means for identifying groups of pixels in the electronically stored image which have similar parameter values as a single portion; and
means for determining a sequence for the portions of the electronically stored image such that separate portions having similar parameter values are grouped in the sequence.

20. The system for simulating the creation of a mock artist's work according to claim 14, wherein the means for displaying includes means for gradually displaying the representation for a portion.

21. The system for simulating the creation of a mock artist's work according to claim 20, wherein the means for displaying comprises means for moving an icon across the computer monitor at areas corresponding to the selected portions; and wherein the means for displaying further comprises means for displaying the representation of each selected portion along the path traversed by the icon.

22. The system for simulating the creation of a mock artist's work according to claim 20, wherein the icon is moved according to a predetermined pattern.

23. The system for simulating the creation of a mock artist's work according to claim 20, wherein the means for displaying first displays the representation of each selected portion while the icon is at the area corresponding to the portion.

24. The system for simulating the creation of a mock artist's work according to claim 14, further comprising a memory storing a plurality of textures corresponding to a plurality of mock artists' styles.

25. The system for simulating the creation of a mock artist's work from an electronically stored image according to claim 24, further comprising means for selecting a mock artist's style from the plurality of mock artist's styles, and wherein the at least one texture corresponding to the selected mock artist's style is used in the means for displaying.

26. The system for simulating the creation of a mock artist's work according to claim 25, further comprising means for selecting a mock artist's style from the plurality of mock artists' styles; and wherein the means for displaying includes means for displaying at least one texture corresponding to the selected mock artist's style.

27. A photography booth for creating a printed output of a mock artist's drawing or painting image, comprising:
a means for accepting monetary payment to enable creation of the printed output;
a printer;
a computer with memory;
means for storing an image in the computer memory;
means for selecting a mock artist having a predetermined artistic style;
means for storing at least one display texture corresponding to the selected mock artist's predetermined artistic style;
means for substituting one or more of the stored textures for different areas of the stored image to create an electronic mock artist's drawing or painting image corresponding to the selected artist's predetermined artistic style; and
means for printing the mock artist's image.

28. The method of claim 8 further comprises, after at least some of the selected portions are displayed, deleting at least some of one or more portions and then recreating the deleted portions.

29. The method of claim 28, wherein the deleting takes the appearance of erasing, wherein the icon is moved over the portions being deleted and then as they are created.

30. The method of claim 29, wherein the icons appearance during erasing is different than its appearance during recreating.
